(19) United States
(12) Patent Application Publication
(10) Pub. No.: US 2008/0191932 A1
(43) Pub. Date: Aug. 14, 2008

(54) Method and Device for Correlation Detection in Spread Spectrum Transmission Systems by Fast Fourier Transformation

(76) Inventors: Erwin Hemming, Herne (DE); Marc Hoffman, Dinslaben (DE)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 11/910,064

(22) PCT Filed: Mar. 31, 2005
(86) PCT No.: PCT/IB2005/000841

§ 371 Date: Oct. 12, 2007

(51) Int. Cl. G01S 1/00; H04B 1/69

(52) U.S. Cl. 342/196; 342/378

(57) ABSTRACT

The invention relates to a method for determining a correlation between an unknown first data signal and a known second data signal in a spread spectrum transmission system consisting of a plurality of signal sources, each source being associated with a unique code, for identifying and tracking the source from which said unknown first data signal originates, the method comprising obtaining a first data signal originating from an unknown source of said plurality of sources; subjecting said first data signal to a Fast Fourier Transformation; selecting a code from said plurality of unique codes associated to said sources; generating a known second data signal in accordance with said selected code; subjecting said second data signal to a Fast Fourier Transformation; multiplying said Fast Fourier transformed first and second data signals; subjecting said multiplied data signal to an inverse Fast Fourier Transformation; determining a correlation between said first and second data signals based on said inverse Fast Fourier transformed data signal.

### FIELD OF THE INVENTION

The present invention relates to a method for determining the correlation between an unknown and a known signal in a spread spectrum transmission system, such as a satellite positioning system, in order to identify and track the source/satellite from which said unknown signal originates. It further relates to a corresponding computer program product, a correlation determining module, and an electronic device comprising this module.

### BACKGROUND OF THE INVENTION

Although the present invention can be used in any spread spectrum transmission system where correlation detection is required, it will in the following be explained with respect to the correlation detection required by a satellite positioning system. Although this is one of the most prominent use cases, the present invention is not limited to be used in such a transmission system.

The Global Positioning System (GPS) has become very popular in recent times. A similar European positioning system called Galileo is currently under development. The ability to easily determine the geographical position of a vehicle or person or the like with considerable accuracy provides many benefits, both in commercial as well as personal applications. The GPS system consists of a plurality of satellites (at least 24), each transmitting data indicating its location and the current time, the latter being provided by an atomic clock on board the satellite. The signals, moving at the speed of light, arrive at a GPS receiver at different times because some satellites are farther away than others. The distance to the GPS satellites can be determined by estimating the amount of time it takes for their signals to reach the receiver, i.e. the time delay with respect to a given reference time. When the receiver has estimated the distance to at least four GPS satellites it can calculate its position in three dimensions. A GPS receiver “knows” the location of the satellites, because that information is included in the satellite transmissions. By estimating how far away a satellite is, the receiver also “knows” it is located somewhere on the surface of an imaginary sphere centered at the satellite. It then determines the sizes of several spheres, one for each satellite. The actual position of the receiver is the point where these spheres intersect.

Mathematically at least four satellites are required for determining the exact position. However it usually suffices to use just three satellites, as the intersection of the respective spheres narrows the position down to two points in space, one of which usually can be excluded simply through plausibility considerations, e.g. because it is located somewhere in space far above earth. The fourth satellite is used for a different purpose instead, to be explained later on.

Since all GPS satellites transmit on the same frequencies each satellite has its own unique code by which it can be recognized. This code is rather complex, mainly in order to improve the error-resistance. The GPS receiver knows these code sequences of each satellite, and they are used for measuring the time delay. To do this the receiver generates a respective code sequence and then compares it with the corresponding code sequence of the individual satellite, to determine the delay time by the offset of the two code sequences. However, for this measurement to be precise it is assumed that the two code sequences are generated at the same point in time, i.e. that both GPS satellite and receiver have the exact identical system time. Since the satellites contain an atomic clock they fulfill this assumption, while the GPS receivers do not contain such expensive clocks.

Thus the receiver uses a kind of trick to synchronize his inaccurate system clock. He determines the distance sphere of a fourth satellite. If the receivers system clock was correct this sphere had to intersect with the point determined from the previous three satellites. If it does the receiver can apply a correction of its system time such that the sphere will intersect afterwards, and then his system clock is synchronized.

From the above short description of the operating mode of GPS receivers it emerges that a major task in the position calculation is to find the position and proportion of a known signal (satellite code) within an unknown signal (received data) to identify a specific satellite. There are basically two tasks to perform when doing position calculations with GPS, first the so-called acquisition which relates to finding a known signal in a received signal to identify the respective satellite, and second the so-called tracking, i.e. to determine the time delay with respect to a reference signal, which is caused by the distance of the respective satellite. For these purposes correlations are needed, wherein the goal of the correlator is to determine which code (corresponding to a specific satellite) is hidden in the actually received data stream. The known code to compare with will be regenerated inside the receiver to compare this known code with code in the received signal.

Conventionally the problem is solved by using correlation techniques in the time domain like matched filter or group correlators. When the number of chips per code, i.e. the complexity of the code increases the amount of taps will increase just as much. With the group correlator approach there are two possibilities, either increasing the group correlator length, comparable to the matched filter option, or increasing the number of iterations per group. The first solution would increase the amount of hardware as the matched filter and the latter would increase the operating frequency in the same fashion. Within an existing architecture the operating frequency usually can not be increased beyond certain limits, and a higher gate count of the hardware causes problems with the size because of the required larger circuit area, and also raises the costs of corresponding devices.

The codes for the GPS system are 1023 chips long. With an oversampling factor of 2 there are already 2046 samples. In the satellites of the upcoming Galileo positioning system this number increases to 16384, i.e. almost eight times longer. Furthermore the comparison has not only to be done once but for all possible code phases. This results in 2046 comparisons for GPS and 16384 for Galileo. In addition the first satellite must be found within a certain time interval, e.g. 8 seconds, thus the search speed must also be taken into account. The satellites are also envisaged to transmit signals with even higher code lengths of e.g. 10230 samples, which has to be considered in future receivers.

### SUMMARY OF THE INVENTION

Now it has been invented a method and devices to improve the comparison capabilities of spread spectrum receivers, such as GPS/Galileo satellite receivers, while avoiding the above discussed problems, particularly reducing the increase in hardware means or operating frequency thereof which is required by an increased code length.

According to a first aspect of the present invention a method is provided for determining a correlation between an unknown first data signal and a known second data signal in a spread spectrum transmission system consisting of a plurality of signal sources. In the spread spectrum transmission system each signal source is associated with a unique code. The method is used for identifying and tracking the source from which the unknown first data signal originates, and comprises obtaining a first data signal originating from an unknown source of said plurality of sources, subjecting said first data signal to a Fast Fourier Transformation, selecting a code from said plurality of unique codes associated to said sources, generating a known second data signal in accordance with said selected code, subjecting said second data signal to a Fast Fourier Transformation, multiplying said Fast Fourier transformed first and second data signals, subjecting said multiplied data signal to an inverse Fast Fourier Transformation, determining a correlation between said first and second data signals based on said inverse Fast Fourier transformed data signal, and identifying and tracking the source from which said unknown first data signal originates based on said correlation and said selected code.

Obtaining of the first data signal in this context shall be understood as both directly receiving a signal from a source as well as retrieving it from a kind of buffer. The positioning calculations in the GPS and also the similar Galileo satellite system require to identify which code belonging to a specific satellite is comprised in a received data signal or sample signal (this also being called acquisition), and then to determine the time delay of the signal based on the position and proportion of the received code in relation to a generated reference code or replica signal (this also being called tracking). For these purposes it is necessary to determine the correlation level between the generated data signal corresponding to a selected code and a data signal received from a yet unknown one of the plurality of satellites. The advantage of the method of performing the necessary correlation determination according to the invention is that an increase in the size of the respective codes does not require increasing the complexity of the receiver hardware (e.g. die area of a hardware chip) in a linear fashion.

Utilizing the Fast Fourier Transformation which can be built up with so-called butterfly elements only requires adding one butterfly element for each transformation or inverse transformation, for example when the code size is doubled, while conventional correlators had to use the double number of elements. Therefore the present invention enables to reduce the gate count for long group codes. However, this reduction will also depend on other parameters like the chosen bit width of the integration memory used. It has to be noted that the actual position calculation requires identifying and tracking at least four satellites, as described before, such that the method of the invention has to be performed for at least a subset or even all of the plurality of satellite identification codes until this provision is met. In order to identify a specific satellite the method described above may be performed for a plurality of selected codes, in order to determine which code provides the highest correlation. The respective satellite can then simply be determined through the allocation to a specific satellite.

According to an exemplary embodiment obtaining said unknown first data signal is preceded by receiving said first data signal from an unknown source of said spread spectrum transmission system, and storing said received first data signal. As mentioned before the inventive method will be performed more than one time, such that it is advantageous to buffer the unknown first signal for further cycles of the inventive method.

According to an exemplary embodiment the method further comprises applying a Doppler shift compensation to the first data signal prior to said Fast Fourier Transformation. This is especially useful in satellite positioning systems. As the signals originating from satellites of the positioning systems will usually experience a Doppler shift in their frequency spectrum because of varying relative velocities with respect to the receiver it is necessary to compensate this shift prior to further processing steps. This may also apply to any other kind of sources that are moving relatively fast with respect to the receiver.

According to an exemplary embodiment the method is performed for a plurality of Doppler shift compensation estimates, and comprises further determining which of said Doppler shift compensation estimates results in the highest correlation of said first and second codes. This is an easy way of choosing an appropriate Doppler shift compensation in case the exact shift value can not be determined otherwise. However this involves successive cycles of the method of the invention for all Doppler shift compensation estimates, which will thus usually require to buffer the input signal, to employ the different shift estimates successively. In order to process all estimation values in an appropriate time this may involve increasing the operating frequency.

According to an exemplary embodiment the method is performed simultaneously for all of said plurality of Doppler shift compensation estimates. This would enable to operate without the previously mentioned buffering of the input signal, however in this manner as much processing branches are required as shift estimates shall be processed. Depending on the actual implementation both ways, i.e. either successive processing with possibly increased frequency or parallel processing with multiple processing branches, may provide specific advantages.

According to an exemplary embodiment the step of applying said Fast Fourier Transformation comprises employing an overlap save method. Due to the block structure of the Fast Fourier Transformation it may show certain interference artifacts, and such can be compensated by utilizing the overlap save method.

According to an exemplary embodiment the step of applying said Fast Fourier Transformation comprises employing an overlap add method. This is an alternative way to compensate for interference within the FFT.

According to an exemplary embodiment the step of determining said correlation is preceded by an integration of said inverse Fast Fourier transformed data signal. Integration is mainly used for amplification purposes but may also be used to process the output signals in many other useful fashions which are per se known.

According to an exemplary embodiment the transmission system is a satellite positioning system, and the sources are satellites of this satellite positioning system. The invention will be described in the context of a satellite positioning system, although the present invention is not to be understood as being limited to this use case.

According to another aspect of the invention a computer program product is provided, comprising program code means for carrying out the method of the invention described above, when said program product is run on a computer or network device.

According to another aspect of the invention a computer program product is provided, comprising program code means embodied on a computer readable medium for carrying out the method of the invention described above, when said program product is run on a computer or network device.

According to another aspect of the invention a computer program product is provided, comprising program code, downloadable from a server for carrying out the method of the invention described above, when said program product is run on a computer or network device.

According to another aspect of the invention a module is provided for determining a correlation between an unknown first data signal and a known second data signal in a spread spectrum transmission system consisting of a plurality of sources, each source being associated with a unique code, for identifying and tracking the source from which said unknown first data signal originates. The module comprises a first Fast Fourier transforming component, adapted for obtaining a first data signal and subjecting it to a Fast Fourier Transformation, a selection component for selecting a code from said plurality of unique codes associated to said sources, a generation component, adapted for generating a known second data signal in accordance with said selected code, a second Fast Fourier transforming component, adapted for subjecting said second data signal to a Fast Fourier Transformation, a multiplication component, adapted for multiplying said first and second Fast Fourier transformed data signals, an inverse Fast Fourier transforming component, adapted for subjecting a data signal from said multiplication component to an inverse Fast Fourier Transformation, and a determining component, adapted for determining a correlation between said first and second data signals based on said inverse Fast Fourier transformed data signal, and an identification component for identifying and tracking the source from which said unknown first data signal originates based on said correlation and said selected code. Such a module provides various advantages which have already been mentioned in the above description of the method of the invention.

According to an exemplary embodiment the module further comprises a first memory component for storing said first data signal and providing said first data signal to said first Fast Fourier transforming component. This enables to use the buffered signal for more than just one processing cycle with different selected codes corresponding to different sources.

According to an exemplary embodiment the module further comprises a component for applying a Doppler shift compensation to said first data signal prior to a Fast Fourier Transformation. The necessity for compensating the Doppler shift has been described above.

According to an exemplary embodiment the module further comprises a second memory component for storing at least one inverse Fast Fourier transformed data signal together with an indication of the Doppler shift compensation estimate said inverse Fast Fourier transformed data signal was subjected to by the Doppler shift compensation component. This enables to perform the already mentioned procedure of applying a plurality of different Doppler shift compensation estimates.

According to an exemplary embodiment the determining component is further adapted for determining from a plurality of inverse Fast Fourier transformed data signals which one provides the highest correlation between said first and second data signals. If a number of Doppler shift compensation estimates is used it is necessary to determine which estimate provides the best correlation, which is enabled by this exemplary embodiment.

According to an exemplary embodiment the components for applying said Fast Fourier Transformations are adapted for employing an overlap save method. This can help to compensate for an interference that may occur because of the block structure of the FFT.

According to an exemplary embodiment the components for applying said Fast Fourier Transformations are adapted for employing an overlap add method. This enables to use an alternative interference reduction method.

According to an exemplary embodiment the module further comprises an integration component for subjecting said inverse Fast Fourier transformed data signal to integration. Integration is a useful way of processing the output signals to be used for many different purposes.

According to an exemplary embodiment the transmission system is a satellite positioning system, and the sources are satellites of this satellite positioning system. The invention will be described in the context of a satellite positioning system, although the present invention is not to be understood as being limited to this use case.

According to another aspect of the invention an electronic device is provided, which is characterized by a module as described above. Employing such a module enables for a reduction in device area and also power consumption of the respective device.

This invention transfers the correlation into the frequency domain using Fast Fourier Transformations (FFTs) and Inverse Fast Fourier Transformations (IFFTs). The chosen FFT structure supports different configurations, needed e.g. for GPS or Galileo satellites in acquisition or tracking operations. By using the FFT approach each doubling of the code length would only need three additional FFT elements (so-called butterflies) and not twice as much as conventional, wherein three FFTs divides into one for replica FFT, one for sample FFT and one for IFFT transformations.

### BRIEF DESCRIPTION OF THE DRAWINGS

The invention will be explained in more detail below, with reference to the attached drawings, which are solely provided by way of example and are not intended to limit the invention to particular implementations depicted. In the drawings

FIG. 1 shows a principle architecture of a GPS/Galileo receiver module according to an embodiment of the invention;

FIG. 2 shows a conventional matched filter configuration;

FIG. 3 shows a conventional group correlator configuration;

FIG. 4a shows a correlator arrangement for GPS acquisition according to an embodiment of the invention;

FIG. 4b shows a correlator arrangement for Galileo acquisition according to the an embodiment of invention;

FIG. 4c shows a correlator arrangement for tracking according to an embodiment of the invention;

FIG. 4d shows an example of an overlap add method according to an embodiment of the invention;

FIG. 5 shows an arrangement for implementing the Fast Fourier Transformation according to the invention;

FIG. 6 illustrates the inventive method for a use in a tracking procedure; and

FIG. 7 illustrates the inventive method for a use in an acquisition procedure.

### DETAILED DESCRIPTION OF THE INVENTION

FFT, with its inverse transformation IFFT, itself is well known and therefore a detailed description of this transformation shall be omitted here.

In the following description the term “K” is to be understood as 1024 instead of 1000, when related to FFT. Therefore e.g. 2K samples mean 2*1024=2048 samples.

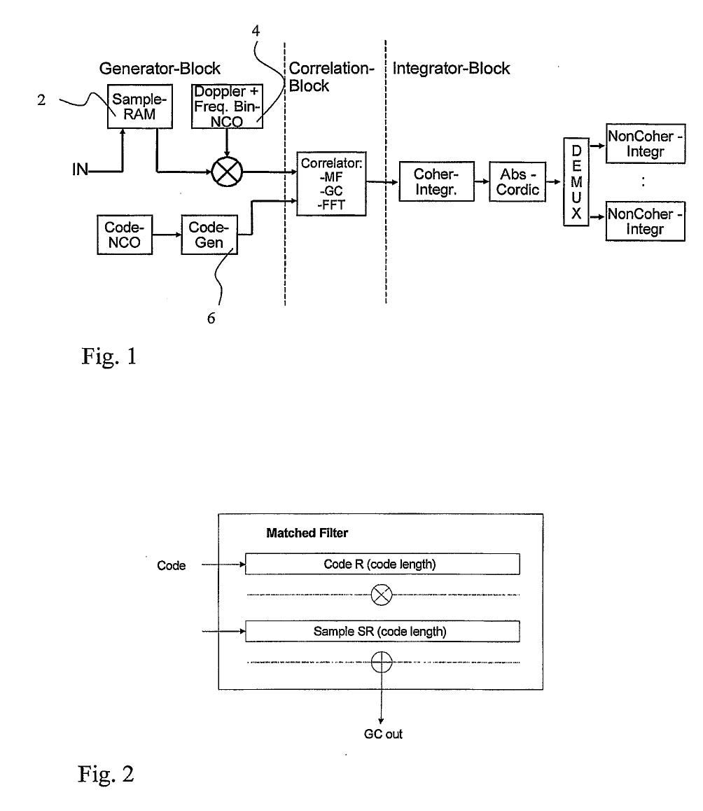

FIG. 1 depicts the principle architecture to be used in a GPS/Galileo receiver according to the invention. The input side, the generator block, is located on the left side of the figure. An incoming satellite signal, herein also called a sample signal, is stored in a sample RAM memory 2. The signal is then outputted to a Doppler shift compensation component 4, where the Doppler shift in the frequency of the satellite signal is removed that is caused by the varying relative velocity with respect to the receiver. As will be explained later this may be performed by employing different Doppler shift compensation estimates, and then choosing the one suited best. A signal to compare the satellite signal with is generated in the other branch of the generator block, component 6. Each satellite of the respective positioning system has allocated a unique code for identification. This code is comprised in the actual signal originating from the respective satellite. While the input of the generator block receives a signal comprising a yet unknown code, the other branch 6 generates a signal comprising a known code, also called replica signal, to compare both signals. Sample and replica signals are fed to the correlation block.

The correlation block according to the invention operates in a manner that will be explained in greater detail in conjunction with the other figures. The output signal of the correlation block in then fed to the integrator block, which will perform coherent and non-coherent integrations as conventionally known. Integration is mainly used for amplification purposes. According to the signal obtained it is then determined if the code underlying the replica signal is the same as the one that is included in the sample signal. If this is the case the receiver now knows from which satellite, corresponding to the unique code, the received input signal originated. The further handling in order to calculate the actual position may be performed according to known procedures and shall therefore not be described in depth here.

The de-multiplexing (demux) block parallelizes the data stream. Up to this block the different frequency bins, generated by the ‘Doppler+Freq. Bin-NCO’ block are handled in serial, one after another, at a higher data rate. This reduces the amount of memory needed to hold the coherent integration results. After de-multiplexing the data stream all non-coherent integrations are available for SW access all the time.

In the demux block data of several correlations are separated, which were processed in one serial path, to parallel paths. This is required since we need the results of all correlations at the end of the processing chain. Furthermore not only the correlations but also different codes are processed in serial which must be separated here again. Thus there is only one line entering into the demux block, but this block does hold different correlations and different codes one after another. The task of the block ABS-cordic is to calculate the absolute value of the complex valued (I/Q) data. A so-called cordic represents a simple HW implementation of this ABS calculation, but any other architecture doing the same job is also possible

FIG. 2 is a diagram of a conventional matched filter. The problems associated with such a conventional filter are that its size depends linearly on the lengths (i.e. the number of chips) of the involved codes, such that an increase in the code size causes a corresponding increase in complexity (hardware means) of the filter, and also that the architecture will remain unused most of the time, thus resulting in a waste of device space and energy consumption.

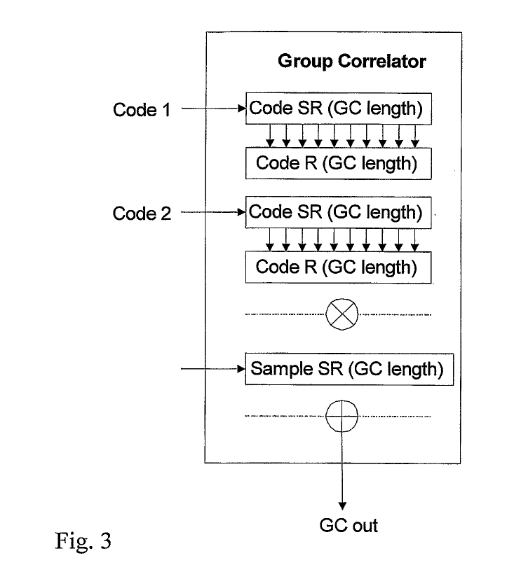

FIG. 3 is a diagram of a conventional group correlator (GC). A group correlator enables to use the same correlation hardware for comparing multiple signals in a multiplexed manner. Similarly an increase in code length requires increasing the complexity of such a group correlator as well. However in this case there are two possibilities of dealing with larger size codes, either increasing the group correlator length, or increasing the number of iterations per group, i.e. increasing the operating frequency. Thus the complexity also of the group correlator depends on the code size in a linear fashion. In the depicted correlator code and sample shift registers (Code 1/2 SR, Sample SR) are running continuously at the same speed. The Code SR is dumped to a code register Code R, always when “GC length” code shifts have been done in Code SR. The Code R is used for the GC out calculations (Code R*Sample SR). The Output “GC Out” is calculated once for every sample, and each of the outputs represents a different correlator with “GC length” number of integration samples. GC Out can be integrated to calculate integration over a full code period. The number of Code R's is only limited by the maximum time multiplexing ability of the hardware.

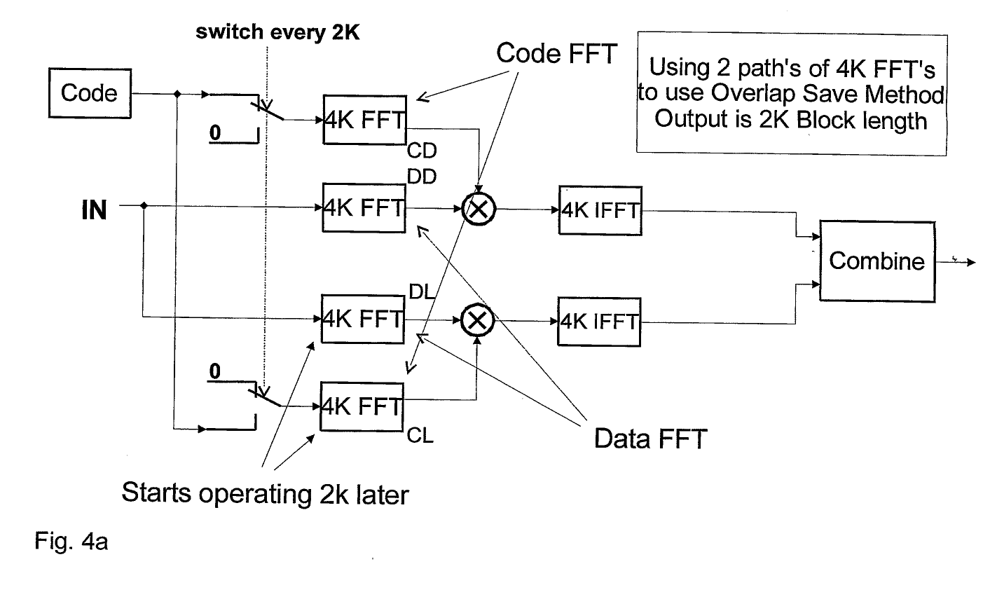

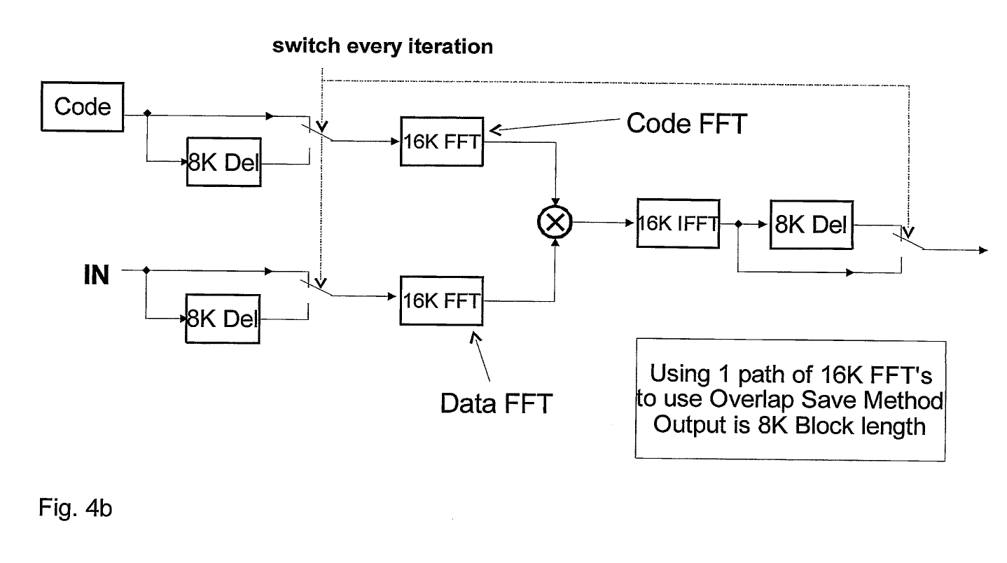

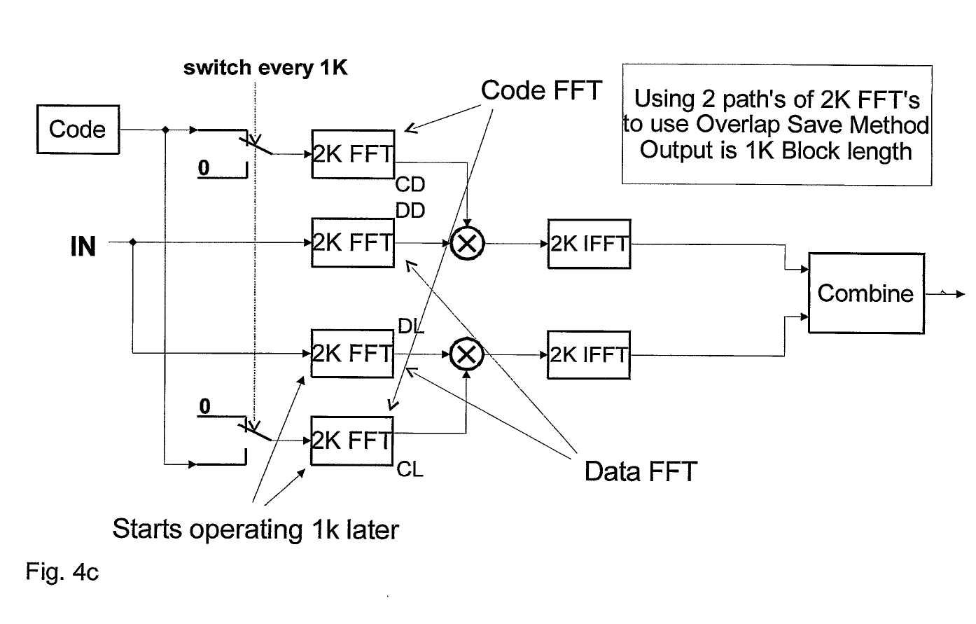

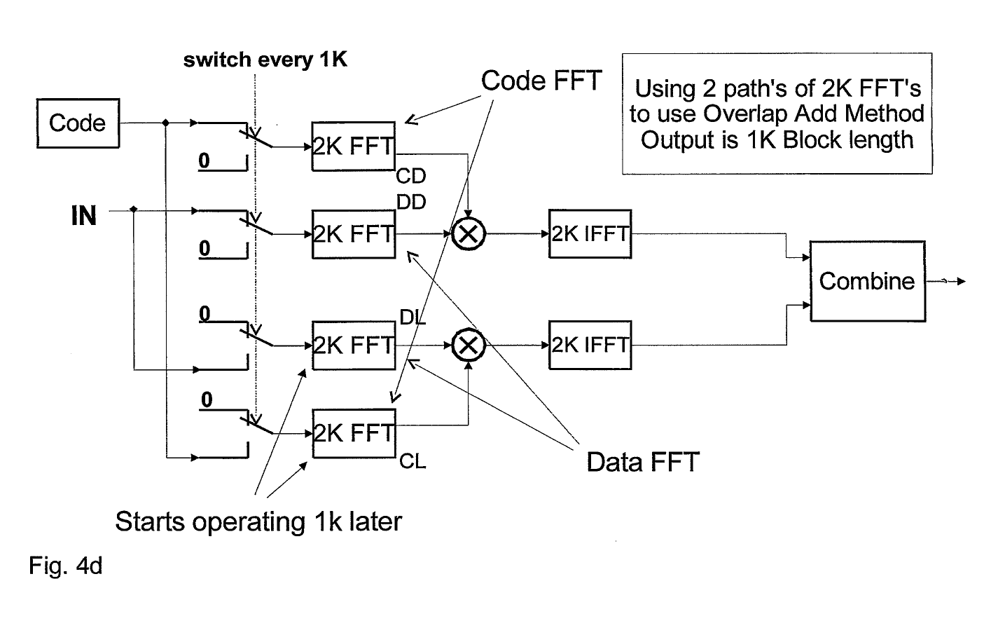

FIG. 4a shows an implementation of the invention to be used in a GPS acquisition procedure. Here two paths of 4K FFT's are utilized to use a so-called overlap save method to reduce interference due to the block scheme of FFT. The uppermost and lowermost 4K FFT blocks are switched every 2K between zero and the replica code signal, respectively, while the upper of the remaining 4K FFT blocks is fed with the input signal whereas the other one is fed with the input signal delayed by 2K. The Fast Fourier transformed code and input signals (upper and lower branch) are multiplied, respectively, and then the multiplied signals are again transformed back using an inverse Fast Fourier transformation. The IFFT transformed signals are then combined, wherein the upper signal depicted is subjected to a 2K delay. The output block size is 2K here.

The scheme depicted in FIG. 4a works in the following way (which is also applicable to FIG. 4d):

An overlap of 50% of the blocks (other overlapping rates are also possible) is assumed here. Then a 2K Code is calculated with a 4K FFT in a way such that the first 2K are set with the code and the 2nd 2K are set to 0 (branches with FFT-CD and FFT-CL). During the time when the code samples of the top 4K FFT are set to 0 (FFT-CD), the code samples of the bottom 4K FFT (FFT-CL) are set to the code samples and vice versa.

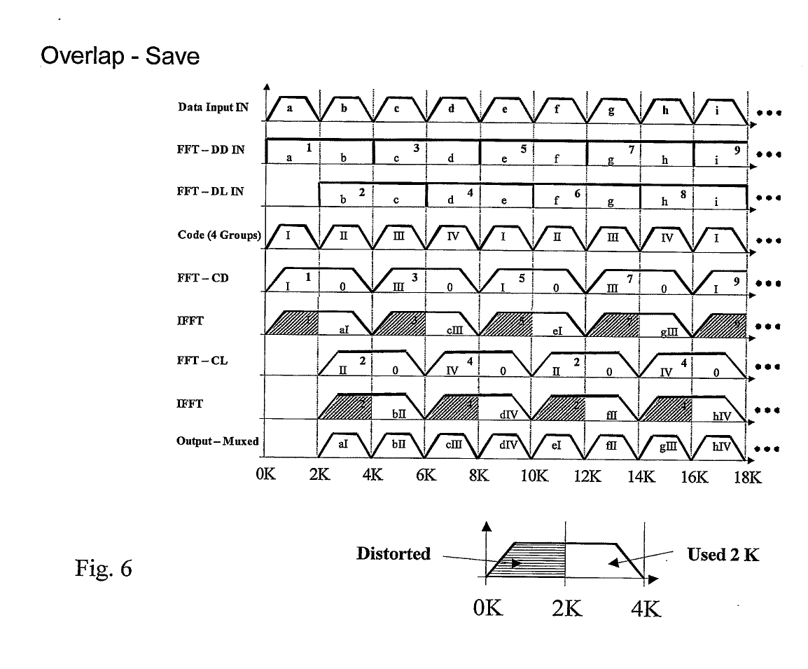

The data FFT in the middle of the figures depends on the used algorithm. In an overlap save method (FIG. 4a), the FFT's FFT-DD and FFT-DL are filled continuously, but the FFT-DL starts 2K symbols later. The first half of the block after the IFFT is then distorted. Therefore only the 2nd half of the IFFT block is used, and the combine unit is just a multiplexer, see also FIG. 6.

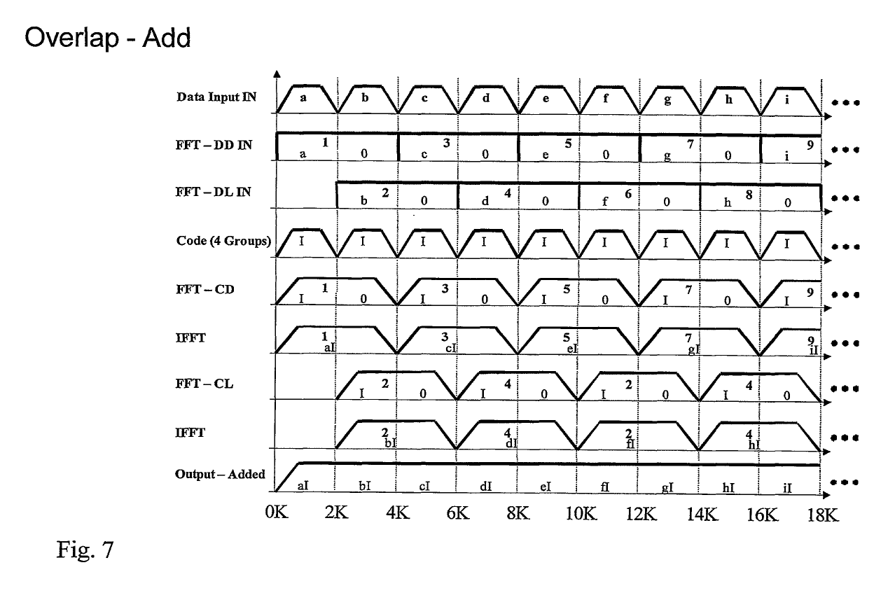

In the overlap add method (FIG. 4d) the 2nd FFT (FFT-DD) are filled with 2K symbols and the last 2K symbols are filled with 0. The 3rd FFT (FFT-DL) is filled with data when the 2nd is filled with 0 and vice versa. Therefore the FFT-DL starts 2K samples later. The combination at the end is then an addition of the two streams from the 4K IFFTs. Therefore this is called an overlap add method, see also FIG. 7.

Both methods, i.e. overlap-save and overlap-add are possible in the two cases. Acquisition and tracking can be performed either with an overlap-add or with overlap-save method. The above description is thus to be understood as exemplary only.

FIG. 4b shows an implementation of the invention to be used in a Galileo acquisition procedure. Here one path with two 16K FFT's is utilized to use a so-called overlap save method, and the output block length is 8K. The depicted implementation uses a two-step iteration process for a 32K Galileo acquisition, wherein two 16K FFT blocks are fed such that for every iteration the inputs of the FFT blocks are switched between the code (replica) signal and the input (sample) signal IN or both signals delayed by 8K, respectively. After they have been Fast Fourier transformed in the 16K FFT blocks both signals are multiplied und subjected to an Inverse Fast Fourier Transformation. The output of the 16K IFFT block is split into a direct output branch (lower one in the figure) and a branch comprising an 8K delay (upper one). The final output of this arrangement is then formed by switching between both output branches for every iteration, and the output has a block length of 8K.

FIG. 4c shows an implementation of the invention to be used in a 2K tracking procedure, with 1K output block length. Here two paths of 2K FFT's are utilized to use an overlap save method to reduce interference due to the block scheme of FFT. The uppermost and lowermost 2K FFT blocks are switched every 1K between zero and the replica code signal, respectively, while the upper of the remaining 2K FFT blocks is fed with the input signal whereas the other one is fed with the input signal delayed by 1K. The Fast Fourier transformed code and input signals (upper and lower branch) are multiplied, respectively, and then the multiplied signals are again transformed back using an inverse Fast Fourier transformation. The IFPT transformed signals are then combined, wherein the upper depicted signal is subjected to a 1K delay.

In principle acquisition and tracking are substantially similar procedures. The same blocks are used in both cases. During acquisition it is required to handle the complete code while in tracking only a small part of it is focused. Another difference is the higher sample rate of the satellite signal during tracking to achieve a greater accuracy.

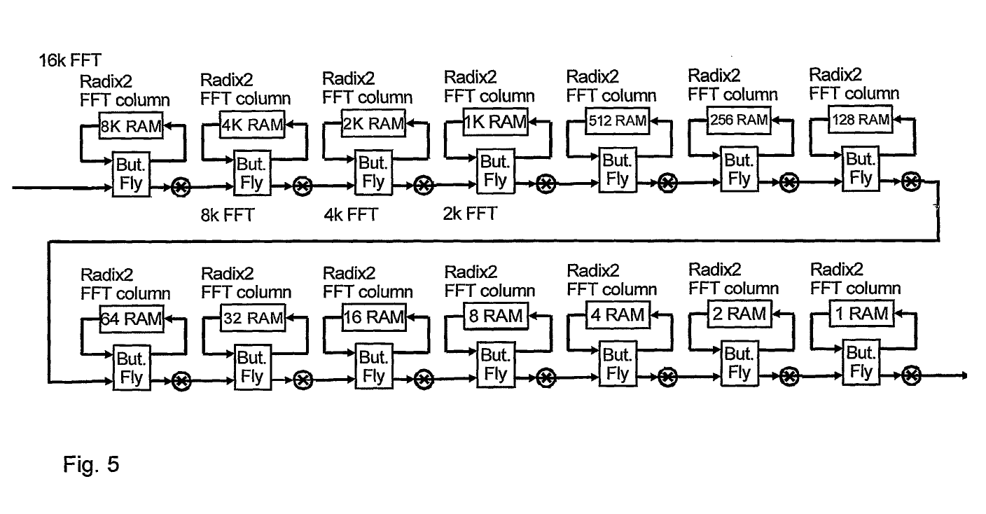

FIG. 5 depicts different possible FFT configurations according to the invention, in the general concept of a serial radix2 butterfly structure. To deal with different code lengths and sample rates this FFT architecture can be configured to support different FFT block lengths, e.g. 2K, 4K or 16K.

FIG. 6 is an exemplary data flow description for the overlap-save method. The correlation signal in this example is 8K long and divided into 4 groups of 2K, to observe a range of 2K out of a period of 8K. The input data stream is divided into groups of 2K. These data packets are numbered with small letters. These groups are then transformed by a 4K FFT via overlap save (fill 2nd half with next group). The lines ‘FFT-DD IN’ (DD=data direct) and ‘FFT-DL IN’ (DL=data late) show which group of data is transformed in which FFT; see also the description of FIGS. 4a and 4d. The ‘Code . . . ’ line shows exemplary 4 different 2k groups of replica code, numbered I, II, III and IV. There can also be any other number of groups. The following line shows how the replica code is distributed to the two code FFT's (FFT-CD and FFT-CL) including the zero-padding as described for FIG. 4a/d.

The 4K FFTs and IFFTs are working in a 2K time shifted mode. Therefore the lines show which FFT/IFFT transforms which group. The results of the two IFFTs are multiplexed to form the output.

The lower part of the figure shows just that the 1st half of a 4K IFFT output block used in overlap save method is distorted and must not be used.

FIG. 7 describes nearly the same as FIG. 6, but uses the overlap-add method (fill 2nd half of data group with 0 and add the results of the two IFFTs). Please refer also to the description of FIG. 4a/d.

Particularly in the use case with a satellite positioning system it may be necessary or at least advantageous to process several satellites, i.e. signal sources, simultaneously. To achieve this, one could use parallel branches for processing several satellites, or one could also double the operating frequency and use some kind of multiplexing.

1. Method for determining a correlation between an unknown first data signal and a known second data signal in a spread spectrum transmission system consisting of a plurality of signal sources, each source being associated with a unique code, for identifying and tracking the source from which said unknown first data signal originates, the method comprising:
obtaining a first data signal originating from an unknown source of said plurality of sources;
subjecting said first data signal to a Fast Fourier Transformation;
selecting a code from said plurality of unique codes associated to said sources;
generating a known second data signal in accordance with said selected code;
subjecting said second data signal to a Fast Fourier Transformation;
multiplying said Fast Fourier transformed first and second data signals;
subjecting said multiplied data signal to an inverse Fast Fourier Transformation;
determining a correlation between said first and second data signals based on said inverse Fast Fourier transformed data signal.

2. Method according to claim 1, further comprising:
identifying and tracking the sources from which said unknown first data signal originates based on said correlation and said selected code.

3. Method according to claim 1, wherein obtaining said unknown first data signal is preceded by:
receiving said first data signal from an unknown source of said spread spectrum transmission; and
storing said received first data signal.

4. Method according to claim 1, further comprising applying a Doppler shift compensation to said first data signal prior to said Fast Fourier Transformation.

5. Method according claim 4, wherein the method is performed for a plurality of Doppler shift compensation estimates, and further comprises:
determining which of said Doppler shift compensation estimates results in the highest correlation of said first and second codes.

6. Method according claim 5, wherein the method is performed simultaneously for all of said plurality of Doppler shift compensation estimates.

7. Method according to claim 1, wherein said step of applying said Fast Fourier Transformation comprises employing an overlap save method.

8. Method according to claim 1, wherein said step of applying said Fast Fourier Transformation comprises employing an overlap add method.

9. Method according to claim 1, wherein said step of determining said correlation is preceded by an integration of said inverse Fast Fourier transformed data signal.

10. Method according to claim 1, wherein said transmission system is a satellite positioning system, and wherein said sources are satellites of said satellite positioning system.

11. Computer program product comprising program code means for carrying out the method of claim 1, when said program product is run on a computer or network device.

12. Computer program product comprising program code means embodied on a computer readable medium for carrying out the method of claim 1, when said program product is run on a computer or network device.

13. Computer program product comprising program code, downloadable from a server for carrying out the method of claim 1, when said program product is run on a computer or network device.

14. Module for determining a correlation between an unknown first data signal and a known second data signal in a spread spectrum transmission consisting of a plurality of signal sources, each source being associated with a unique code, for identifying and tracking the source from which said unknown first data signal originates, the module comprising:
a first Fast Fourier transforming component, adapted for obtaining a first data signal and subjecting it to a Fast Fourier Transformation;
a selection component for selecting a code from said plurality of unique codes associated to said sources;
a generation component, adapted for generating a known second data signal in accordance with said selected code;
a second Fast Fourier transforming component, adapted for subjecting said second data signal to a Fast Fourier Transformation;
a multiplication component, adapted for multiplying said first and second Fast Fourier transformed data signals;
an inverse Fast Fourier transforming component, adapted for subjecting a data signal from said multiplication component to an inverse Fast Fourier Transformation; and
a determining component, adapted for determining a correlation between said first and second data signals based on said inverse Fast Fourier transformed data signal.

15. Module according to claim 14, further comprising: an identification component for identifying and tracking the source from which said unknown first data signal originates based on said correlation and said selected code.

16. Module according to claim 14, further comprising a first memory component for storing said first data signal and providing said first data signal to said first Fast Fourier transforming component.

17. Module according to claim 14, further comprising a component for applying a Doppler shift compensation to said first data signal prior to a Fast Fourier Transformation.

18. Module according to claim 17, further comprising a second memory component for storing at least one inverse Fast Fourier transformed data signal together with an indication of the Doppler shift compensation estimate said inverse Fast Fourier transformed data signal was subjected to by the Doppler shift compensation component.

19. Module according to claim 14, wherein said determining component is further adapted for determining from a plurality of inverse Fast Fourier transformed data signals which one provides the highest correlation between said first and second data signals.

20. Module according to claim 14, wherein said components for applying said Fast Fourier Transformations are adapted for employing an overlap save method.

21. Module according to claim 14, wherein said components for applying said Fast Fourier Transformations are adapted for employing an overlap add method.

22. Module according to claim 14, further comprising an integration component for subjecting said inverse Fast Fourier transformed data signal to an integration.

23. Module according to claim 14, wherein said transmission system is a satellite positioning system, and wherein said sources are satellites of said satellite positioning system.

24. Electronic device, characterized in that it comprises a module according to claim 14.
